(19) United States
(12) Patent Application Publication
(10) Pub. No.: US 2024/0359634 A1
(43) Pub. Date: Oct. 31, 2024

(54) Vehicle Mounted Pivoting Load Lifting Rack

(71) Applicant: Michael Avendt, Lenox, MI (US)

(72) Inventor: Michael Avendt, Lenox, MI (US)

(21) Appl. No.: 18/653,838

(22) Filed: Jul. 17, 2024

Related U.S. Application Data
(60) Provisional application No. 63/449,510, filed on Mar. 2, 2023.

(51) Int. Cl. B60R 9/06

(52) U.S. Cl. CPC B60R 9/06

(57) ABSTRACT

An easy to load vehicle mounted pivoting load lifting rack to facilitate loading, a method of making same, and a method of using it. The novel means for easing the load lifting is achieved by incorporating a rack for resting a load thereon in combination with a torsion spring, providing an easy-to-use, unexpectedly good result.

### CROSS-REFERENCE TO RELATED APPLICATIONS

This application claims the benefit under 35 U.S.C. 119 (e) of U.S. Provisional Application No. 63/449,510, filed on Mar. 2, 2023.

### BACKGROUND OF THE INVENTION

### 1. Field of the Invention

The present invention relates to a vehicle mounted pivoting load lifting rack, methods of manufacturing the rack, and methods of using same. More particularly, the invention relates to an easy to lift, load carrying rack for mounting on a pickup truck and service body style trucks.

### 2. Description of the Prior Art

Conventional truck racks mounted on pickup trucks re well known in the art, including one of the most common types of stationary load lifting and equipment racks mounted on pickup trucks. For example, in order to use such a stationary rack for carrying an extension load lifting on the truck, the load lifting must be lifted up without aid up onto the load lifting rack. This example relates especially to a load lifting rack that includes a side mounted load lifting rack on the outer edge of the truck.

However, practitioners of those inventions have become aware of certain problems which are presented by those prior art inventions. One particular problem that has plagued users has been that it is difficult to lift a heavy load, like the load lifting, up onto the rack without assistance. There are complexities which give rise to injuries and physical disabilities.

It would be of a great advantage to the vehicle and construction industry if there was provided an easy to load lifting rack and loading mechanism, and method of making it, as well as a method of using it.

### SUMMARY OF THE INVENTION

In accordance with the above-noted advantages and desires of the industry, the present invention provides an easy to load vehicle mounted pivoting load lifting rack to facilitate loading, a method of making same, and a method of using it. The novel means for easing the load lifting is achieved by incorporating a rack for resting a load thereon in combination with a torsion spring, providing an easy-to-use, synchronizing motion that has an unexpectedly good result.

This novel combination of a pivoting rack with a torsion spring to ease loading is a greater combination than a predictable use of prior art elements with their established functions. My new easy to load pivoting rack design overcomes many of the aforementioned problems with the prior art because loading cargo, such as load lifting of sports equipment, onto a truck rack is no longer a back breaking activity.

One specific preferred aspect of my invention has certain features including an easy to load pivoting cargo rack made almost effortless with the inclusion of a torsion spring and a pivoting rack to lower the rack for easier loading.

The invention is particularly useful for any type of cargo carrying application on a cargo rack of a truck, service style or utility bed style trucks especially useful in the contractor and construction industries that require the transport of large load lifting, pipes and/or other long construction materials. Further, the load lifting rack can also be used for loading and carrying sports equipment such as kayaks, etc.

Although the invention will be described by way of examples herein below for specific aspects having certain features, it must also be realized that minor modifications that do not require undo experimentation on the part of the practitioner are covered within the scope and breadth of this invention. Additional advantages and other novel features of the present invention will be set forth in the description that follows and in particular will be apparent to those skilled in the art upon examination or may be learned within the practice of the invention. Therefore, the invention is capable of many other different aspects and its details are capable of modifications of various aspects which will be obvious to those of ordinary skill in the art all without departing from the spirit of the present invention. Accordingly, the rest of the description will be regarded as illustrative rather than restrictive.

### BRIEF DESCRIPTION OF DRAWINGS

For a further understanding of the nature and advantages of the expected scope and various aspects of the present invention, reference shall be made to the following detailed description, and when taken in conjunction with the accompanying drawings, in which like parts are given the same reference numerals, and wherein:

FIG. 1 is a side perspective view of a vehicle mounted pivoting load lifting rack device made in accordance with the present invention, shown in the down position ready to be loaded with cargo, such as a load lifting;

FIG. 2 shows a first aspect where an operator begins use by placing a load lifting on the lifting rack;

FIG. 3. is a perspective view showing the load lifting being supported by the rack;

FIG. 4 shows the operator securing the load lifting to the rack to prevent slippage during transport;

FIG. 5 shows the operator lifting the loaded pivoting rack into position for transport;

FIG. 6 shows the operator locking the pivoting rack for securely going down the road;

FIG. 7 shows another aspect of the present invention wherein a kayak is the cargo to be transported;

FIGS. 8A-8C show side elevational views of the pivoting rack in a progression of positions from loading to transporting;

FIG. 9A is a side elevational view of the load lifting rack in a down position;

FIG. 9B is a side elevational view of the load lifting rack in an up position;

FIG. 10A is a close up view of the pivot mechanism;

FIG. 10B is a top view of the pivot mechanism;

FIG. 11 is a top plan view of the pivot bar;

FIG. 12 is a top view of the torsion bar in accordance with the present invention;

FIGS. 13A and 13B are side elevational views of the locking stanchion;

FIGS. 14A and 14B are side elevational views of hydraulic struts;

FIG. 15 shows relative movement of the load lifting rack;

FIG. 16A illustrates one aspect of attachment to a vehicle;

FIG. 16B shows yet another aspect of attachment;

FIG. 17 is a rear elevational view of the present invention;

FIG. 18 is a side elevational view of the present load lifting rack in a loaded position;

FIG. 19A is a side elevational view of another aspect of the present invention useful for carrying a bicycle;

FIG. 19B is a side elevational view of another aspect of the present invention useful for carrying a bicycle in an upside down position;

FIG. 20 is a perspective view of a cushioned hook;

FIG. 21A is a side cutaway view of the hook of FIG. 20;

FIG. 21B is yet another aspect of FIG. 21A;

FIG. 22 is a top perspective view of a bicycle rack;

FIG. 23 is a multiple carrier rack; and

FIG. 24 is a rear elevational view of a service style truck sowing the relative placement of the present invention.

### DETAILED DESCRIPTION OF THE INVENTION

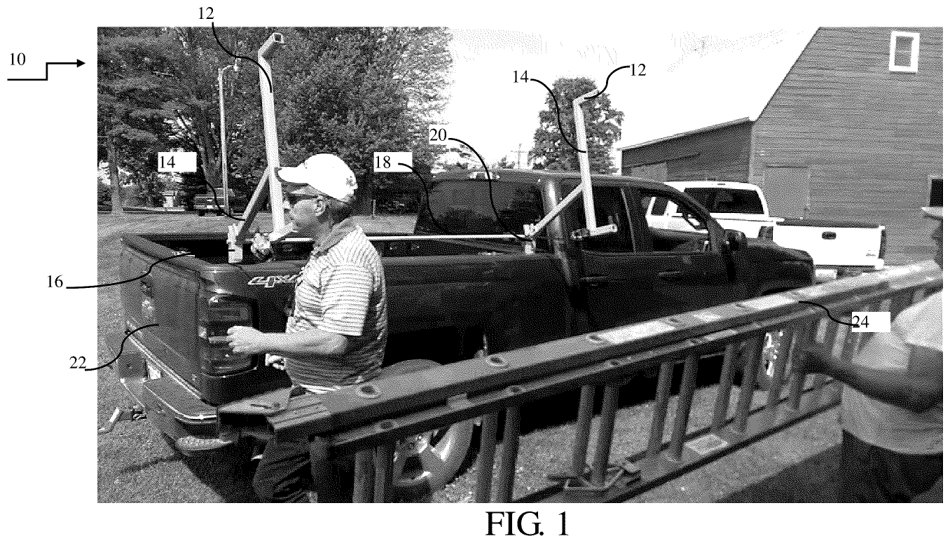

Referring first to FIG. 1, there is shown load lifting device 10 includes load arm support 12 and riser stanchion 14 connected by pivot knuckle 16. Synchronizing torsion pivot tube 18 connects to vehicle mounting receiver 20 received within the truck bed of vehicle 22. Ladder 24 is lifted and will be resting on riser stanchion 14.

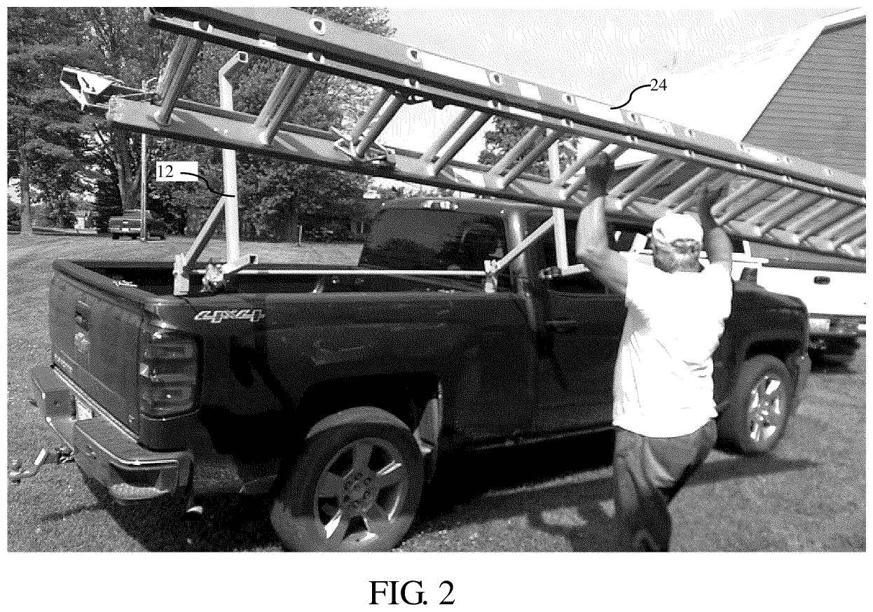

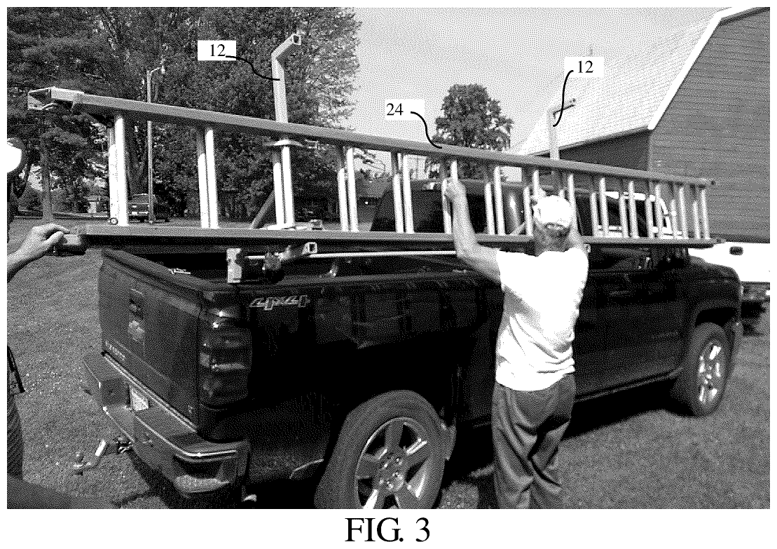

FIG. 2 shows the initial process of loading ladder 24 onto load arm support 12. FIG. 3 shows the final step of loading ladder 24 onto load arm support 12, ready to be lifted into position.

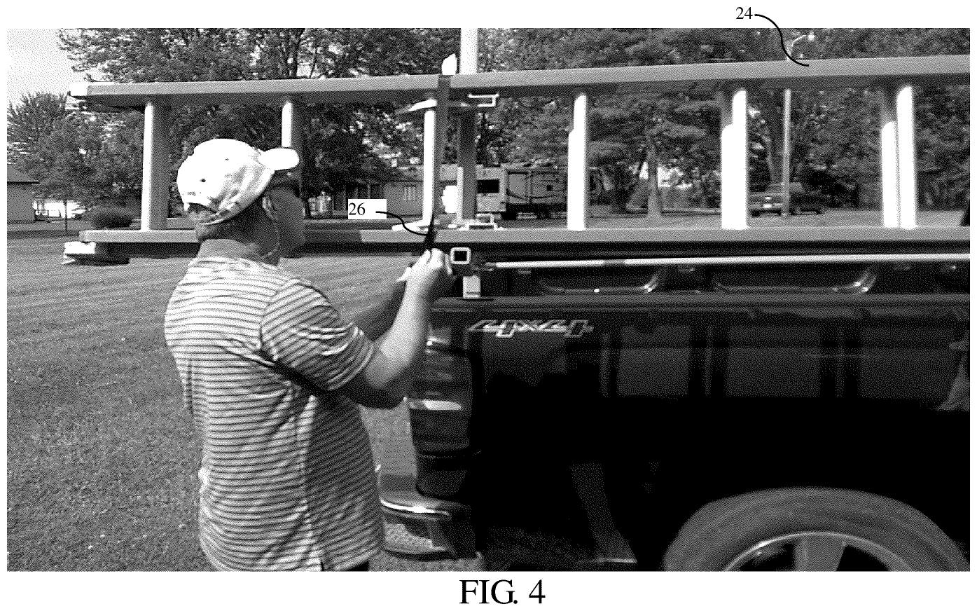

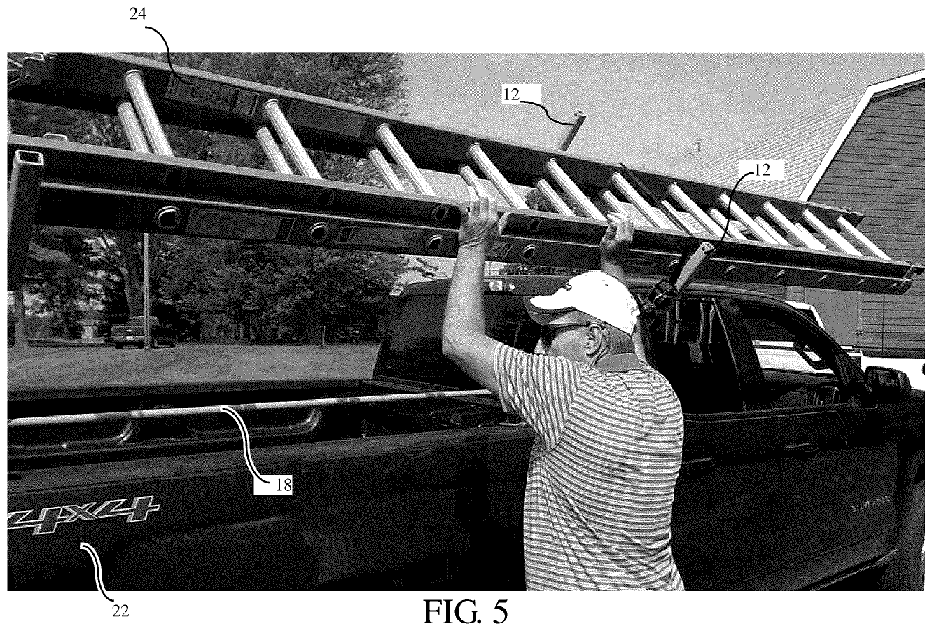

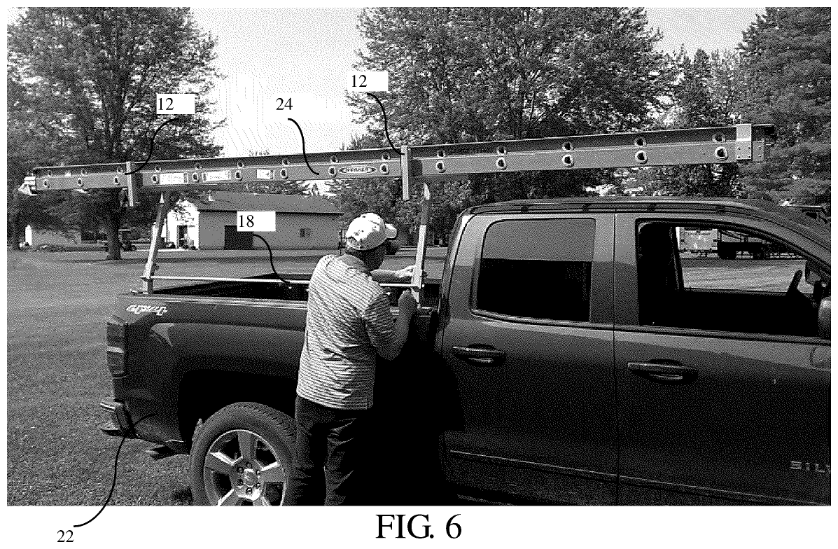

FIG. 4 gives the final position of ladder 24 prior to lifting, and being held in position to secure ladder 24 with tie-down ratchet strap 26. FIG. 5 illustrates the lifting position to put ladder 24 up into position on load arm support 12 by synchronizing torsion pivot tube 18 received within truck bed of vehicle 22. FIG. 6 shows the final position of ladder 24 in the up position extending over the cab of vehicle 22, and locked into place now that it is in the up position ready to travel down the road.

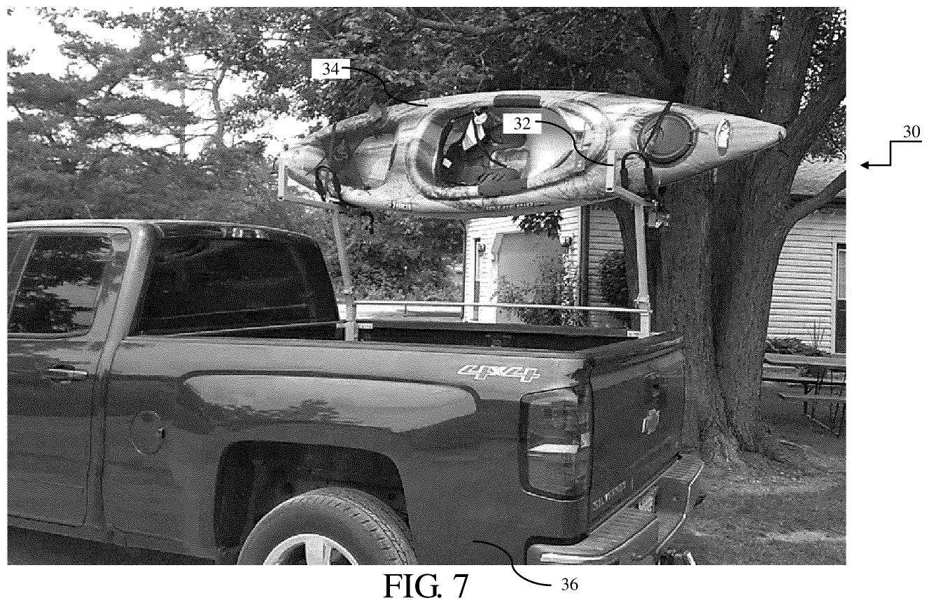

While the first aspect showed a ladder rack adapted for long articles, including pipes, lumber, etc., FIG. 7 shows another aspect for transport of sporting equipment such as kayak 34 held by J-shaped kayak adapter 32 of kayak rack generally denoted by numeral 30. Again, this aspect of a kayak rack 30 is secured within a truck bed of vehicle 36. Synchronizing torsion pivot 38 is again utilized for ease of lifting.

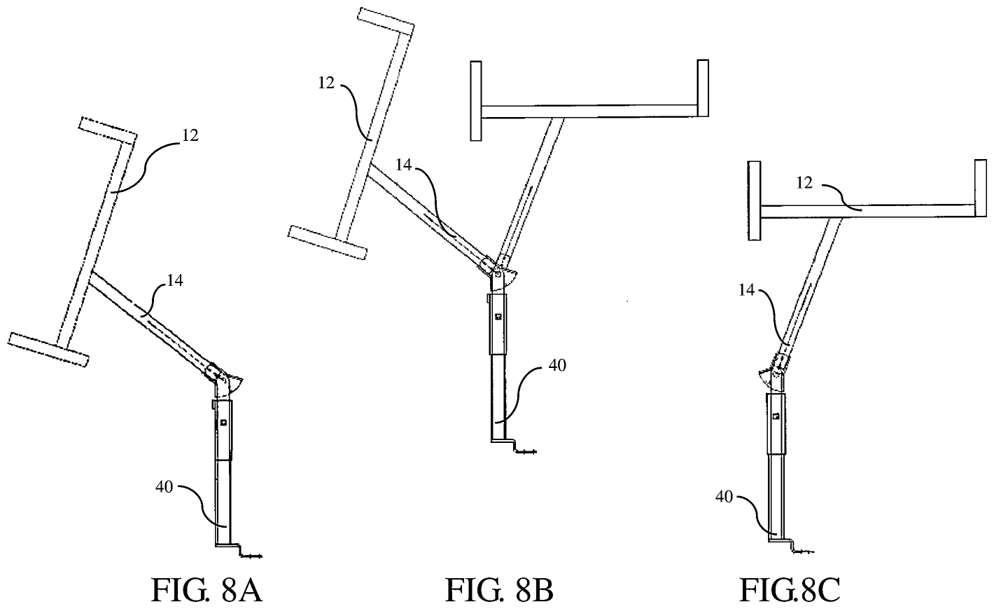

With combined reference to FIGS. 8A-8C a load arm support 12 is permanently affixed to riser stanchion 14 and pivotally connected to lower truck mount stanchion 40 which is semi-permanently secured to a vehicle having a truck bed. Lower truck mount stanchion 40 is preferably secured within the truck bed. A synchronizer is most advantageously used to make two stanchions move simultaneously. The synchronizer makes the load lift evenly from front to back during the lifting operation.

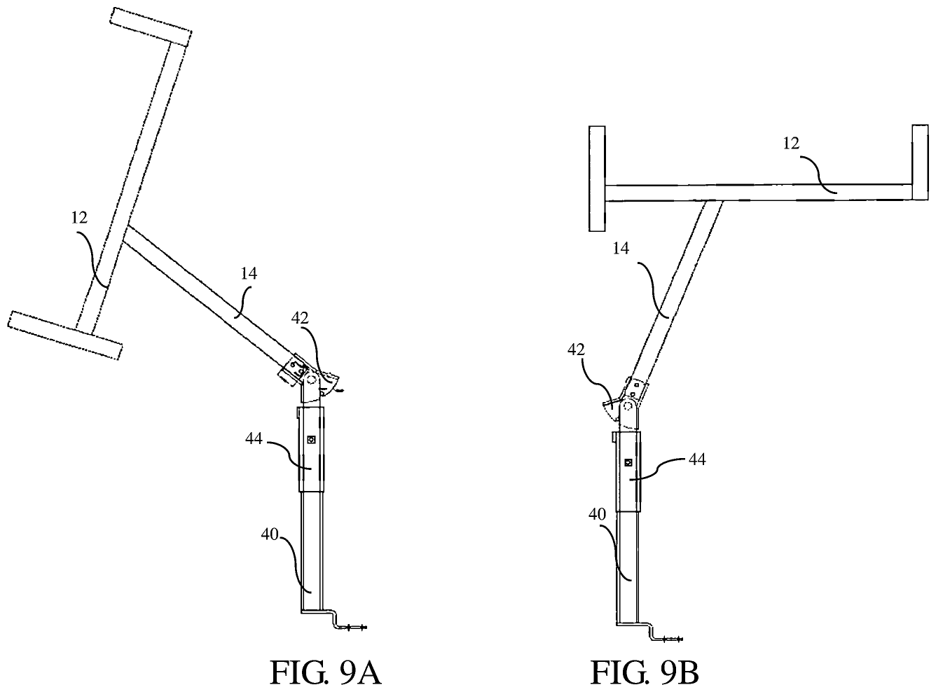

FIGS. 9A-9B show yet another aspect of the present invention wherein a side elevational view of the present invention is shown in first a loading position in FIG. 9A and then in a road-ready up position in FIG. 9B. Again, load arm support 12 is rigidly affixed to riser stanchion 14 which is pivotally connected to truck mount 44 by knuckle 42. Lower truck mount stanchion 40 may be secured to a pick up truck bed by lower truck mount stanchion 40 at its bottom, and truck mount 44 is secured semi-permanently to a side wall of a vehicle truck bed.

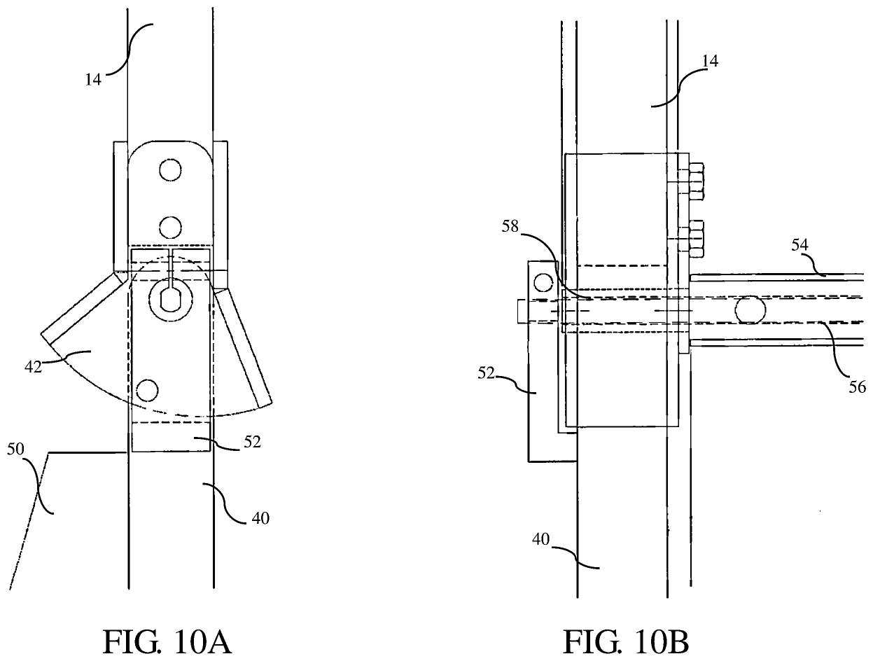

FIGS. 10A-10B are a front elevational view and side elevational view, respectively, of the knuckle 42 providing pivotal motion for the riser stanchion 14. Knuckle 42 is pivotally connected to fixed spring anchor 52 which received torsion pivot tube 54 and torsion spring 56. Torsion spring spindle 58 is received through knuckle 42 to allow pivotal movement of riser stanchion 14.

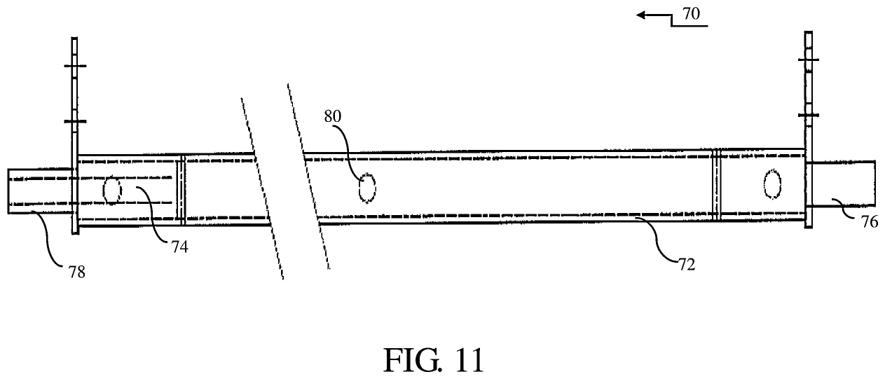

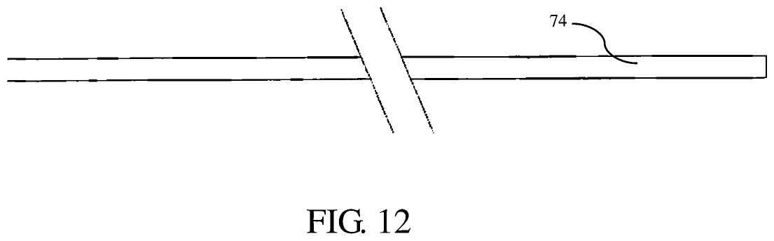

FIG. 11 illustrates a synchronizing torsion assembly generally denoted by numeral 70 incorporating a synchronizing torsion pivot tube 72. Received therein is torsion spring 74 at one end with a solid spindle portion 76 at the other end. Solid spindle 76 is held in place, while torsion spring 74 can be rotated, providing resistance when lowering a load lifting device, not shown here but shown as numeral 10 in FIG. 1. Hollow spindle 78 receives torsion spring 74 and provides ease of lifting once the load lifting device 10 is urged into the up, road-ready position. Internal spring anchor 80 is received within synchronizing torsion pivot tube 72. FIG. 12 shows torsion spring 74.

In addition to the preferred aspect of the employment of a torsion spring to ease loading, there are various envisioned aspects of the present invention, wherein the inventor envisions the use of other suitable numerous counter-balance mechanisms, including commercially available coiled torsion springs, gear boxes with motors, viscous dampeners, speed control devices, torsion bars, hydraulic and or gas struts, and or synchronizers, whether alone or in communication to provide easy to lift loading devices.

The torsional stress capability is a measure of the ability of a material to withstand a twisting load. Torsional stress is a form of shear stress experienced by a body when a twisting force is applied. It is the ultimate strength of a material subjected to torsional loading, and is the maximum torsional stress that a material sustains before rupture. Alternate terms are modulus of rupture and shear strength. Preferably, the torsion bars and springs will be from 0 to 1000 Newton/meters or Pascals. To calculate the preferred strength, the magnitude of the torsional stress depends on a few factors including the distance of the applied force from the center of rotation, the twisting moment, and the polar moment of inertia. These factors are all considered in the equation for torsional stress below:

t=Tr/J
Where:
t=Torsional stress
T=Transmitted torque
r=Distance from the center of rotation
J=Polar moment of inertia area

To calculate the torsional stress, the torsional stress formula must be used. Firstly the value for the variables: the distance between the applied load and the center of rotation, the torque being transmitted, and the polar moment of inertia area must all be identified. Secondly, the values need to be substituted into the torsional stress equations. Then the formula will lead to a value for the torsional stress in pascals.

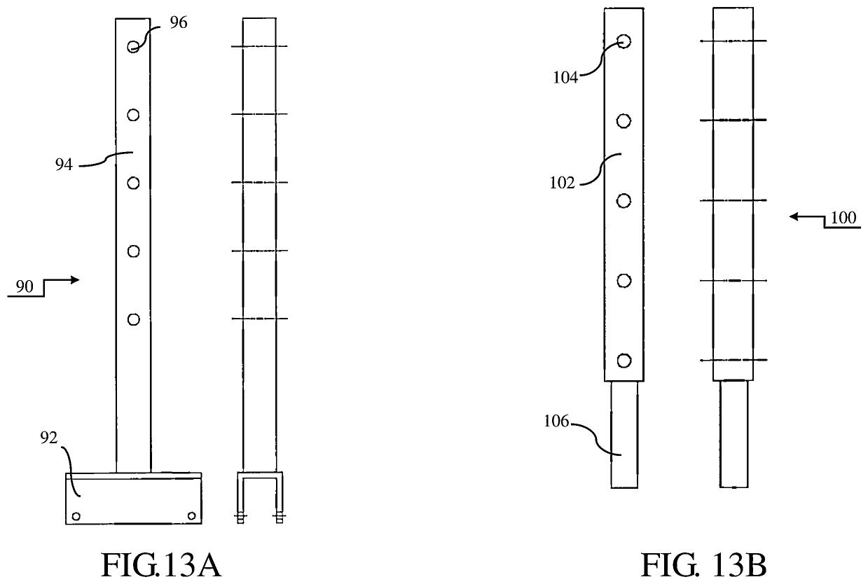

In order to provide adjustability, FIGS. 13A and 13B include a mid-support riser 90 and an outboard extender 100, respectively, including a capital U-shaped channel mount 92 to be received over the side wall of a truck bed. A riser stanchion 94 has securing receivers 96 throughout the length of riser stanchion 94 for adjustability. FIG. 13B illustrates yet another aspect of an adjustable stanchion, such as outboard extender 100 including a male support post 106 that supports outboard extender stanchion 102 having adjustable securement receivers 104 throughout its length to provide adjustability of height.

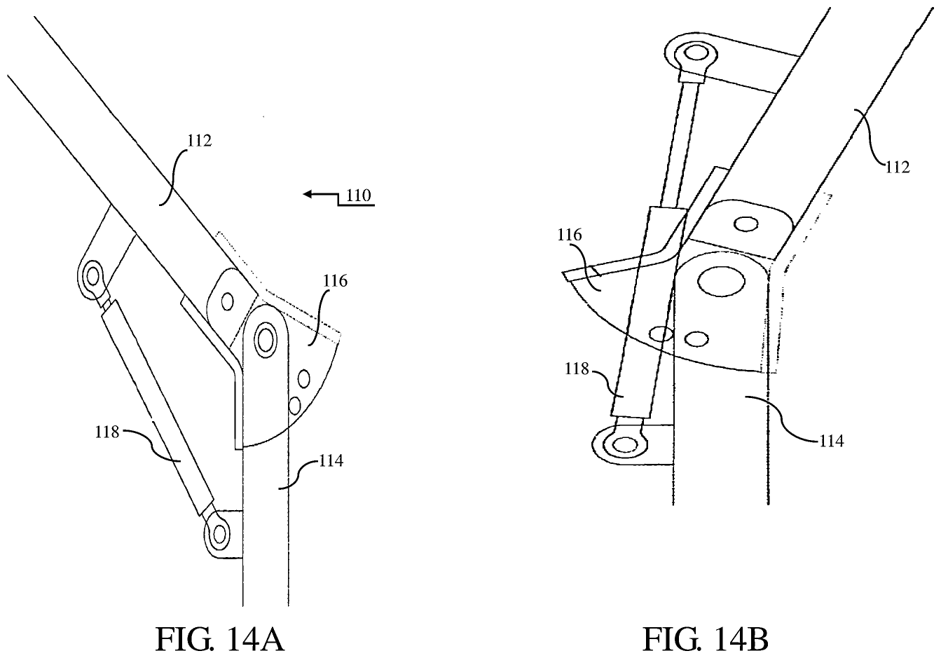

With combined reference to FIGS. 14A and 14B, in yet another aspect of the present invention, a hydraulic rotational assembly generally denoted by numeral 110 includes a riser stanchion 112 in a loading position with a hydraulic strut 118 to assist lifting with ease. As can be seen, lower truck mount stanchion 114 is pivotally connected to riser stanchion 112 by knuckle assembly 116. In FIG. 14B, relative position of riser stanchion 112 is shown in the up, road-ready position with hydraulic strut 118 being extended. Knuckle assembly 116 allows for pivoting riser stanchion 112 by hydraulic strut 118.

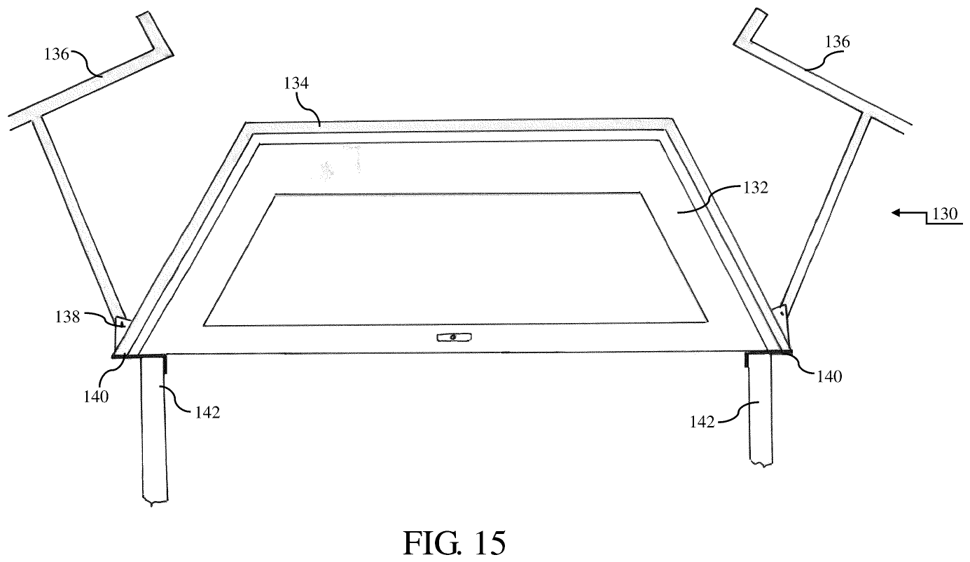

FIG. 15 shows a double-rack load lifting device generally denoted by numeral 130, including a pair of vertical support arms 136 attached to truck bed sidewalls 142 by pivot members 138 on top of the pick up truck bed top rail 140. In this aspect, truck bed cap 132 can remain in position while using the double-rack load lifting device 130. Truck bed cap 132 is shown in this rear elevational view underneath rack frame support 134. Once the racks 136 are up in position, resting on rack frame support 134 the load carried thereon is secure. Racks 136 may be replaced with custom “antlers” for carrying different loads. These “antlers” are replaceable with any suitable design of load carrier design that is dependent upon a particular load. Obviously, there would be too many designs to mention here.

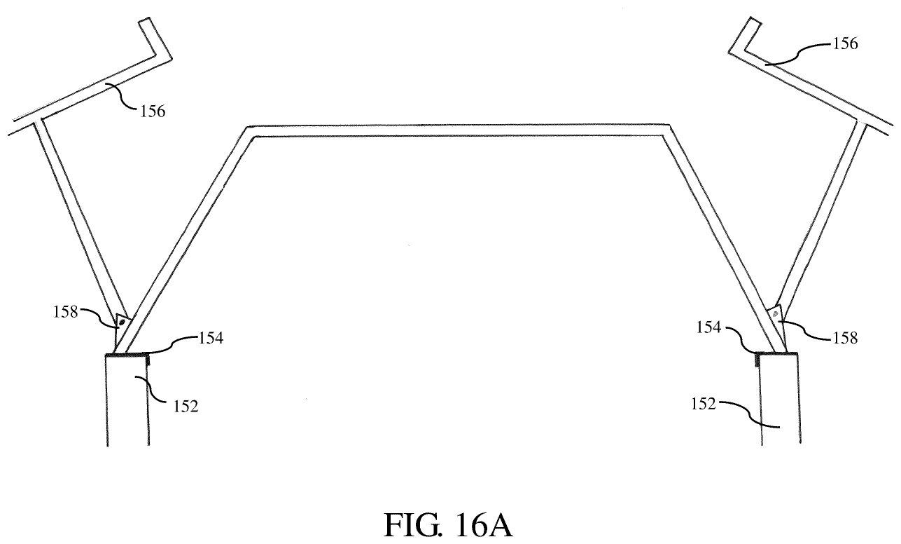

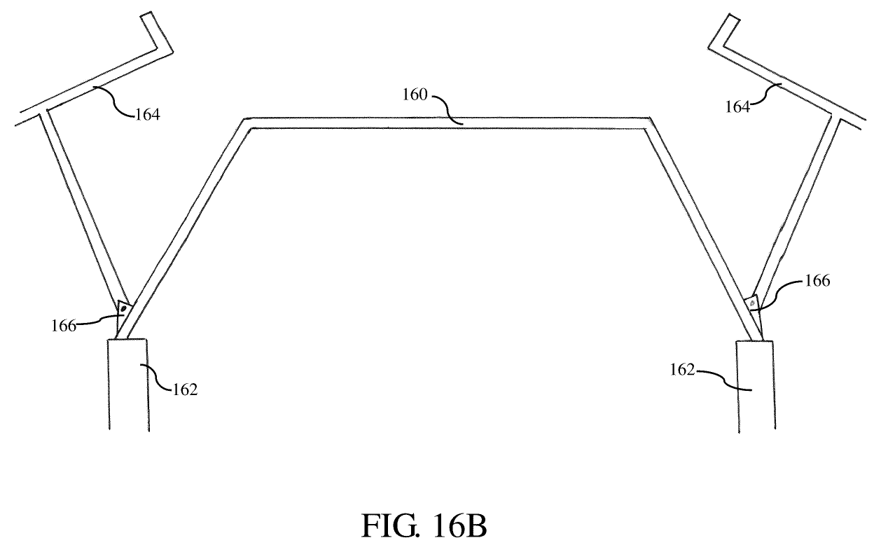

FIG. 16A shows yet another aspect of the present invention illustrating a rigid rack support 150 permanently attached to truck bed sidewalls 152 by mounting brackets 154. Lifting racks 156 are pivotally connected to pivot brackets 158 to place lifting racks 156 in proper position, once loaded and lifted up over the truck on top of rigid rack support 150.

FIG. 16B illustrates another aspect of the present invention, wherein a rigid rack support 160 is mounted into a recess in the truck bed sidewalls 162. Similar to FIG. 16A, lifting racks 164 are pivotally connected to rack pivots 166.

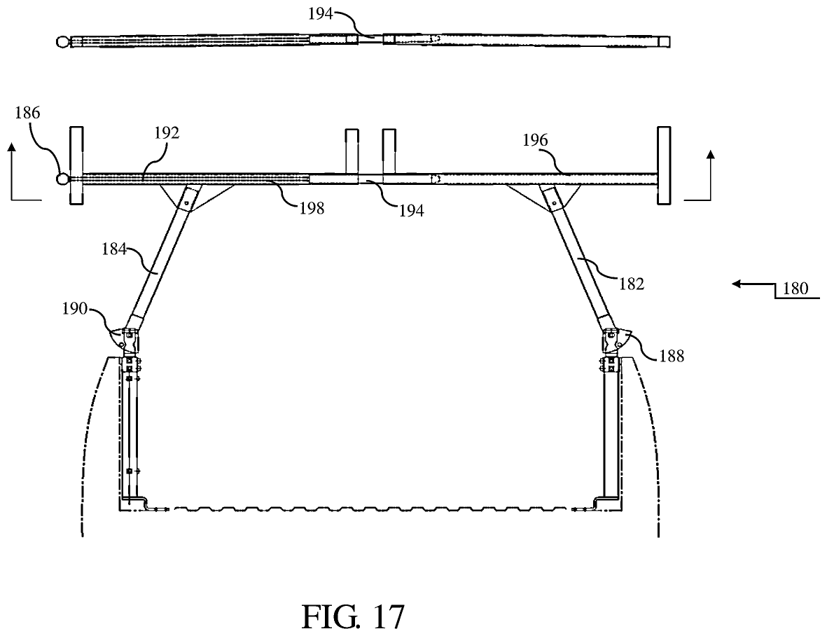

FIG. 17 illustrates an interlocking aspect of the present invention generally denoted by numeral 180, which is a double rack system. Double rack system 180 includes first and second vertical support arms 182 and 184, respectively. Pull rod 186 engages and disengages connector rod 192 urging locking bar 194 into place once vertical support arms 182 and 184 are lifted up over the truck. A first removable antler 196 and second removable antler 198, once loaded and lifted are interconnected by locking bar 194. First and second antlers 196 and 198 are pivotally mounted onto the truck bed by first pivot mechanism 188 and second pivot mechanism 190. Again, they may be replaced with custom “antlers” for carrying different loads. These “antlers” are designed to be removable and replaceable with any suitable “antler” design of a load carrier design that is dependent upon the configuration of a particular load.

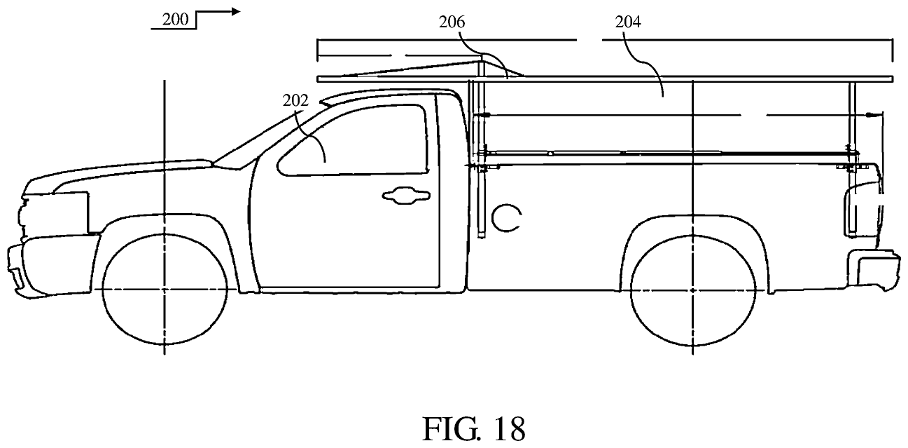

We now look at FIG. 18 showing a side elevational view of a conventional pick up truck with my novel over-cab support 200. Pick up truck 202 has a load lifting rack 204 made in accordance with the present invention mounted inside the bed of pick up truck 202. Load support 206 not only supports lifting load rack 204 but also prevents load lifting rack 204 from forward or backward motion while on the road.

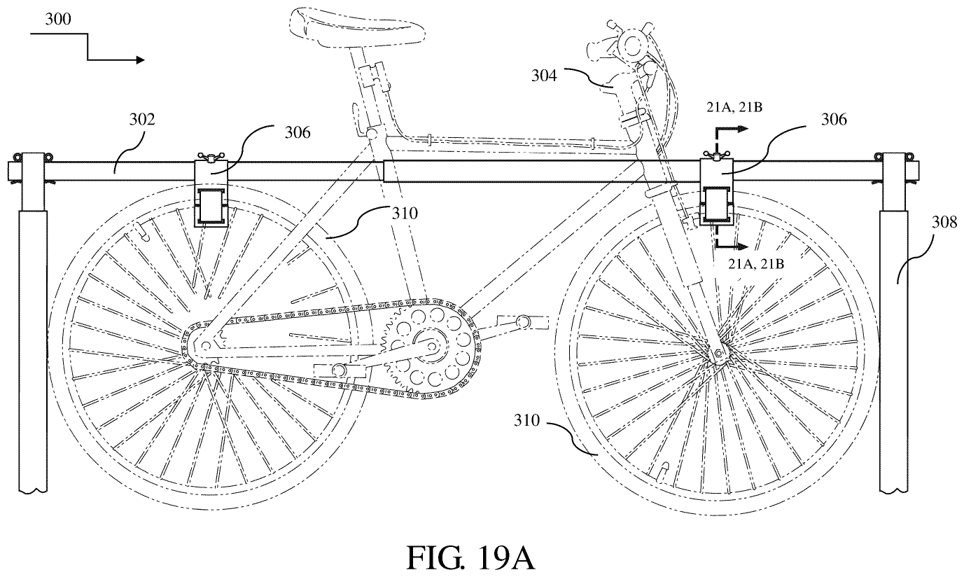

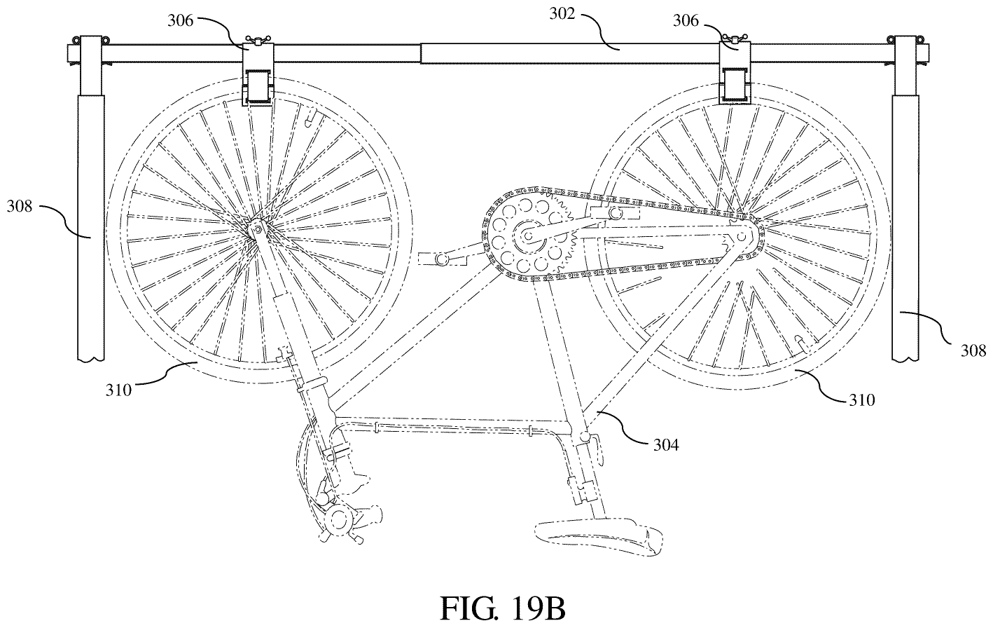

With combined reference to FIGS. 19A and 19B, there is illustrated yet two more aspects of the present invention useful as a bicycle rack generally denoted by numeral 300, and includes a horizontal support 302 which supports a bicycle 304. Vertical struts 308 are attached within a truck bed in a similar fashion as with previous aspects of this invention. Extending downwardly from horizontal support 302 are cargo hooks 306. Bicycle 304 is supported on cargo hooks 306 on bicycle wheel 310. In this aspect, bicycle 304 is supported in an upright position. In another possibly preferred aspect, FIG. 19B shows bicycle 304 in an upside down configuration being supported by cargo hooks 306 and supported by horizontal support 302.

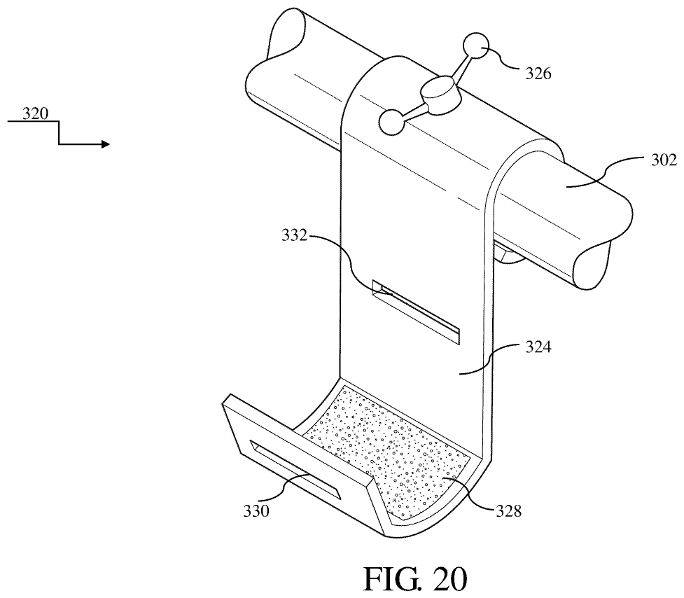

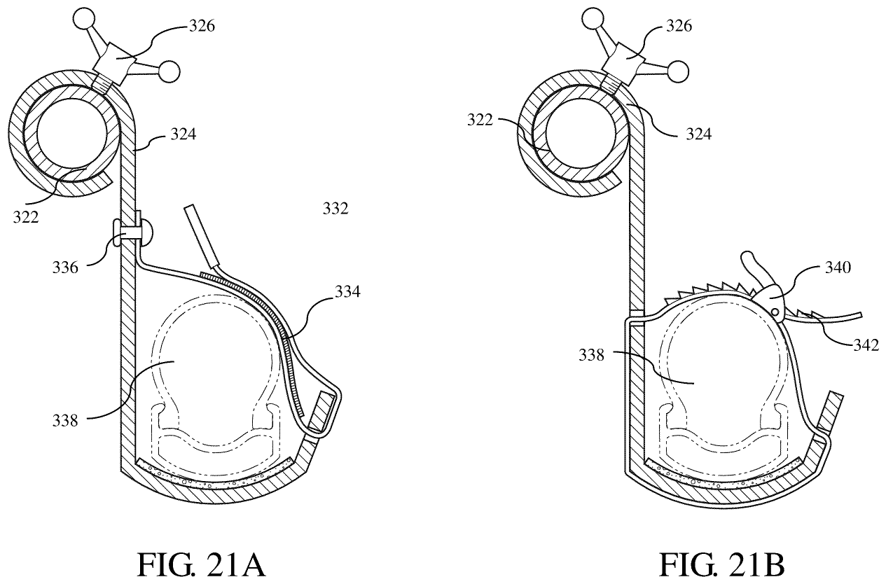

FIG. 20 is a perspective view of the cargo hook 306 as previously shown in cargo hooks 306 in FIGS. 19A and 19B, being supported by horizontal support 302. Cargo hook 320 includes a downwardly extending hook extension 324 including a tensioning device 326 to secure cargo hook 320 in position on horizontal support 302. Cargo hook 320 includes an optional cushion support 328 so as not to damage a bicycle wheel. Optional slots 330 and 332 may be included to receive securements that are more fully described hereinbelow in FIGS. 21A and 21B.

In practice, any desired cargo is to be suspended on cargo hook 306 and secured by any chosen securement device. As the vehicle rack is lifted, hook 320 rotates about horizontal support 302 to maintain the cargo in its upright position, which is then secured in place by tensioning device 326 after loading and lifting up into its road-ready position. Consequently, the cargo is secured within the cargo hook 320, and once lifted into position, it is secured about horizontal support 302 so that the cargo does not become displaced during transport. Tensioning device 326 is loosened prior to loading to allow for rotation during the lifting procedure. Thereafter, tensioning device 326 is tightened down to secure hook 320 during transportation.

With combined reference to FIGS. 21A and 21B, FIG. 21A shows a cutaway side view of the cargo hook 320 shown in FIG. 20. FIG. 21A illustrates a first aspect of a securement strap 334 held in place by a screw 336 inserted through slots 330 and 332 of FIG. 20. Preferably, securement strap 334 holds bicycle wheel 338, which is shown in phantom, as supported by cargo hook 320. Meanwhile, FIG. 21B shows another aspect of securement with a ratchet 340 securing ratchet strap 342 as threaded through slots 330 and 332 of FIG. 20. Any other suitable means of securing bicycle cargo 338 to prevent slippage may be utilized and are to be considered within the scope and spirit of this invention.

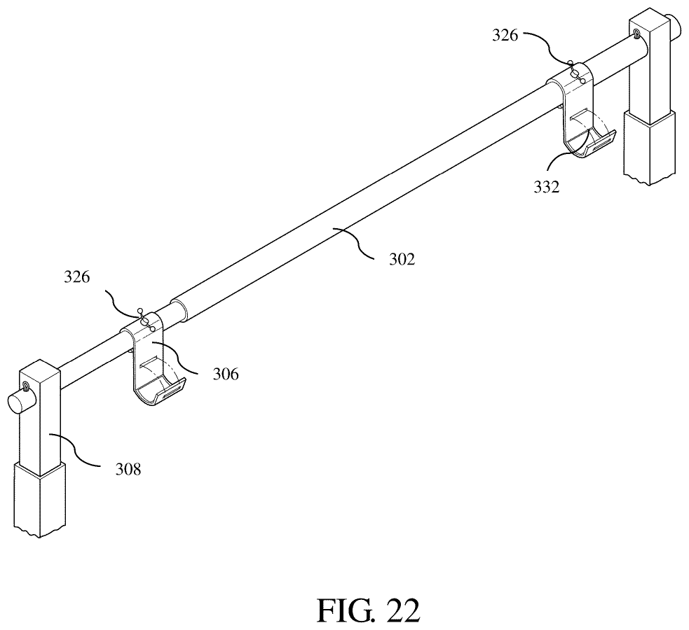

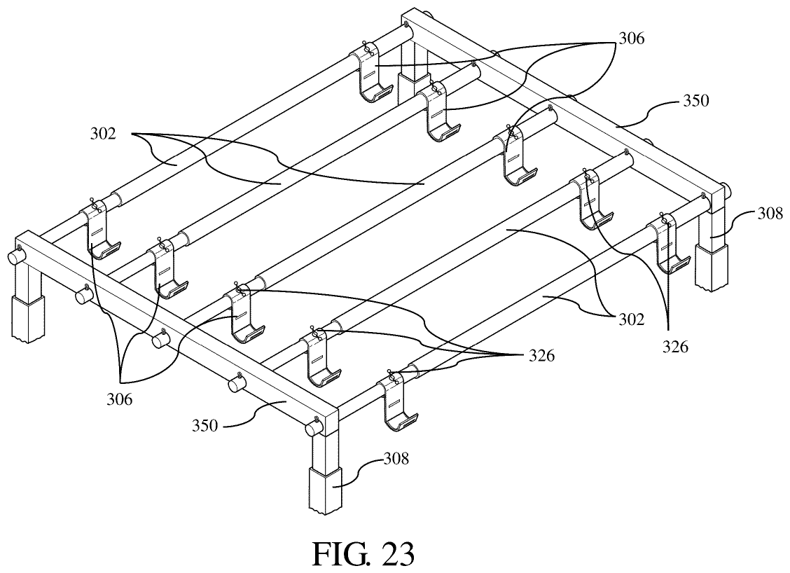

With combined reference to FIGS. 22 and 23, wherein FIG. 22 shows the basic elements of the rack made in accordance with the present invention. As previously discussed with reference to FIG. 20, hook 306 rotates freely about horizontal support 302 when the tensioning device is loosened before loading. After lifted into position, tensioning device 326 is tightened to secure the hook 306 to the horizontal support 302. Horizontal support 302 can be a telescoping arm that may be adjusted to accommodate either different sizes of bicycles or different size of truck beds. FIG. 23 incorporates the same concept as FIG. 22, although in a multiple format. The function of carrying multiple bicycles, or any other cargo such as ladders etc., shall be lifted by the vehicle rack into position similar to the other aspects of this invention. Before loading bicycles or other cargo, tensioning device 326 is loosened to allow rotation upon lifting and tightened when in its final position.

Preferably, when lifting bicycles, a first bicycle shall be mounted in one direction, with additional bicycles staggered front to back to avoid collision between handle bars. Similarly, in the event of lifting ladders, or other cargo, it may be advisable to stagger them as well to avoid collision between parts. The horizontal support bar 302 may be a telescoping arm supporting the cargo hooks 306, but cargo hooks 306 will support any kind of selected cargo and will be cushioned by an optional pad 328. As before, slots 332 may be utilized to secure the cargo in cargo hook 306.

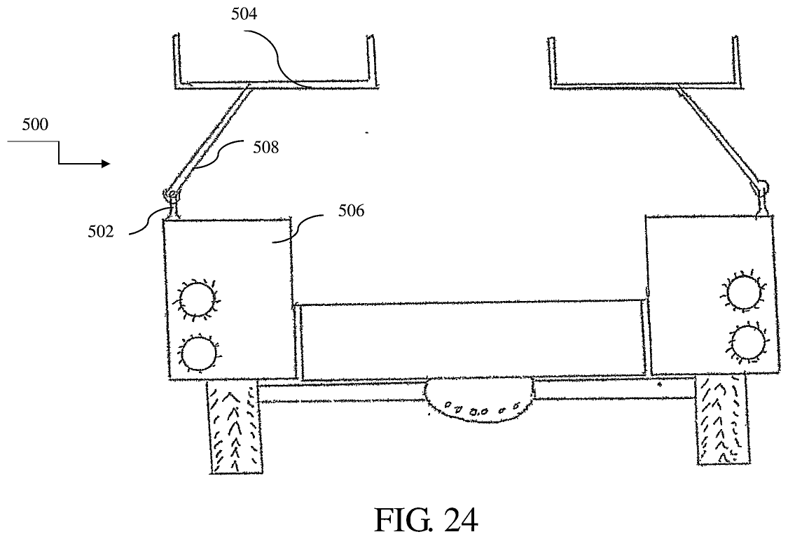

FIG. 24 illustrates how the present invention would be successfully mounted on a service style truck commonly used by utility and service companies worldwide. Service style truck 500 includes a side mounted utility box 506. On top of the utility box 506 is mounted a pivoting mounting bracket 502 that connects a stanchion 508 with load specific “antlers” 504 on top. This allows “antler” 504 to be lowered to receive a load. Once loaded, the load is pushed upward into its road-ready position. Again, load specific “antlers” 504 may be replaceable dep permanently securing the “antlers” of the load lifting devices allow for putting a truck inside a garage that has a door that is too short to normally allow a truck with the load lifting device affixed thereto.

In summary, numerous benefits have been described which result from employing any or all of the concepts and the features of the various specific aspects of the present invention, or those that are within the scope of the invention. The load lifting rack acts to ease the lifting requirements allowing for use by a single operator.

The foregoing description of a preferred aspect of the invention has been presented for purposes of illustration and description. It is not intended to be to be exhaustive or to limit the invention to the precise form disclosed. Obvious modifications or variations are possible in light of the above teachings with regards to the specific aspects. The aspect was chosen and described in order to best illustrate the principles of the invention and its practical applications to thereby enable one of ordinary skill in the art to best utilize the invention in various aspects and with various modifications as are suited to the particular use contemplated. It is intended ending on the circumstances of load necessity.

In various envisioned aspects of the present invention, the inventor envisions the use of numerous counter-balance mechanisms, including torsion springs, gear boxes with motors, viscous dampeners, speed control devices, torsion bars, hydraulic and or gas struts, and or synchronizers, whether alone or in communication to provide easy to lift loading devices as described more fully herein above.

Furthermore, the load lifting devices made in accordance with the present invention may be removable to allow a vehicle to fit within a garage or other enclosure. Semi-that the scope of the invention be defined by the claims which are appended hereto.

1. A vehicle lifting rack, for lifting cargo onto a vehicle, comprising:
at least one vertical lifting stanchion
an attachment bracket to secure the at least one vertical lifting stanchion to a vehicle
a horizontal support extending from the at least one vertical lifting stanchion
a torsion spring connected to the at least one vertical lifting stanchion
wherein the torsion spring reduces the effort required to lift cargo onto the vehicle.

2. The vehicle lifting rack of claim 1, wherein the at least one vertical lifting stanchion extends outside the vehicle prior to loading the cargo.

3. The vehicle lifting rack of claim 1, wherein said attachment bracket is pivotally mounted to the vehicle and the at least one vertical lifting stanchion.

4. The vehicle lifting rack of claim 1, wherein the horizontal support includes cargo hooks to secure cargo during transport.

5. The vehicle lifting rack of claim 1, wherein the torsion spring in an effort reduction spring within a synchronizing torsion pivot tube.
